(19) United States
(12) Patent Application Publication
(10) Pub. No.: US 2010/0265712 A1
(43) Pub. Date: Oct. 21, 2010

(54) CASING FOR ENCLOSING ELECTRONIC DEVICE

(75) Inventors: Jitender Pratap Singh, New Delhi (IN); Vijay Malhi, New Delhi (IN)

Correspondence Address: DAVID A. GUERRA;INTERNATIONAL PATENT GROUP, LLC, Suite 700, 1816 Crowchild Trail N.W., CALGARY, AB, T2M 3Y7, CA

(73) Assignee: MOSER BAER INDIA LIMITED, New Delhi (IN)

(21) Appl. No.: 12/625,738

(22) Filed: Nov. 25, 2009

(30) Foreign Application Priority Data
Apr. 20, 2009 (IN) 899/CHE/2009
Apr. 22, 2009 (IN) 936/CHE/2009
Apr. 29, 2009 (IN) 998/CHE/2009

(51) Int. Cl. F21V 33/00; B23P 11/00

(52) U.S. Cl. 362/253; 29/428

(57) ABSTRACT

A casing for enclosing an electronic device is provided. The electronic device includes one or more electrical components and a light source placed on an electronic substrate. The light source is located at a periphery associated with the electronic device, such that light emitted from the light source travels in a direction parallel to a longitudinal axis of the electronic device. The casing includes a first covering component and a second covering component adapted to engage together mechanically and enclose at least one section of the electronic device that includes the light source. The second covering component includes one or more reflecting surfaces adapted to reflect light emitted from the light source towards a pre-defined view zone. The reflecting surfaces are inclined at one or more pre-defined angles with respect to the longitudinal axis of the electronic device.

### CROSS-REFERENCE TO RELATED APPLICATION

This application claims the benefit of priority under 35 U.S.C 119 to co-pending India Patent Application No. 998/CHE/2009 filed on Apr. 29, 2009, India Patent Application No. 936/CHE/2009 filed on Apr. 22, 2009, and India Patent Application No. 899/CHE/2009 filed on Apr. 20, 2009. The entire disclosure of the prior applications is incorporated herein by reference.

### BACKGROUND OF THE INVENTION

1. Field of the Invention

The embodiments herein relate, in general, to covering mechanisms. More particularly, the embodiments relate to a casing for enclosing an electronic device.

2. Description of the Prior Art

A typical Universal Serial Bus (USB) flash drive includes a light indicator that generates light indications for indicating the current state of the USB flash drive. Conventional casings for enclosing such USB flash drives are designed in a manner that a transparent portion is placed vertically above the light indicator.

In case of a USB flash drive in which a light indicator is placed horizontally, a transparent portion needs to be placed horizontally in front of the light indicator. However, since the USB flash drive generally lies horizontally when connected to a computer or a laptop, the horizontal placement of the light indicator and the transparent portion restricts view of light indication. This becomes even more problematic when the USB flash drive is very small in size and has a very small light indicator.

In light of the foregoing discussion, there is a need for a casing that allows a viewer to view light indications from a comfortable position. In this regard, the present invention substantially fulfills this need. In this respect, the casing according to the present invention substantially departs from the conventional concepts and designs of the prior art, and in doing so provides an apparatus primarily developed for the purpose of providing a view of light indications from a comfortable position, compared to conventional casings.

### SUMMARY OF THE INVENTION

In view of the foregoing disadvantages inherent in the known types of casings now present in the prior art, the present invention provides an improved casing, and overcomes the above-mentioned disadvantages and drawbacks of the prior art. As such, the general purpose of the present invention, which will be described subsequently in greater detail, is to provide a new and improved casing and method which has all the advantages of the prior art mentioned heretofore and many novel features that result in a casing which is not anticipated, rendered obvious, suggested, or even implied by the prior art, either alone or in any combination thereof.

An embodiment relates to a casing for enclosing an electronic device.

Another embodiment relates to a casing that allows a viewer to view light indications from a comfortable position.

Embodiments herein provide a casing for enclosing an electronic device. The electronic device includes one or more electrical components and a light source placed on an electronic substrate. The light source is located at a periphery associated with the electronic device, such that light emitted from the light source travels in a direction parallel to a longitudinal axis of the electronic device. The casing includes a first covering component and a second covering component. The first covering component includes one or more first portions at a first periphery associated with the first covering component. The second covering component includes one or more second portions at a second periphery associated with the second covering component. The first portions and the second portions substantially complement each other. The first portions and the second portions are capable of being engaged together mechanically to enclose at least one section of the electronic device in between the first covering component and the second covering component. The at least one section of the electronic device includes the light source. The second covering component also includes one or more reflecting surfaces adapted to reflect light emitted from the light source towards a pre-defined view zone. In accordance with an embodiment herein, the pre-defined view zone is a zone through which light reflected from the reflecting surfaces is visible to a viewer.

In accordance with an embodiment herein, the reflecting surfaces are inclined at one or more pre-defined angles with respect to the longitudinal axis of the electronic device. The pre-defined angles may, for example, range from 15 degrees to 50 degrees.

In accordance with an additional embodiment herein, the reflecting surfaces are coated with a reflective material.

In accordance with an embodiment herein, at least one of the first covering component or the second covering component includes the pre-defined view zone. The pre-defined view zone may, for example, include at least one of a hole, a transparent portion, or a translucent portion.

In accordance with an additional embodiment herein, the electronic device includes one or more recessed portions at the periphery associated with the electronic device, and at least one of the first covering component or the second covering component includes one or more protruding portions at an inner periphery, such that the recessed portions and the protruding portions substantially complement each other and engage together mechanically.

In accordance with an embodiment herein, the casing is made of at least one of acrylic, polyurethane, thermoplastic rubber, or plastic.

The casing allows transmission of light emitted by the light source through the pre-defined view zone, and allows a viewer to view the light from a comfortable position.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF DRAWINGS

Embodiments herein will hereinafter be described in conjunction with the appended drawings provided to illustrate and not to limit the scope of the claims, wherein like designations denote like elements, and in which:

FIG. 1A depicts a top view of a casing enclosing an electronic device; FIG. 1B depicts a sectional view of a section A-A, in accordance with an embodiment herein;

FIG. 2A depicts a top view of a casing enclosing an electronic device; FIG. 2B depicts a sectional view of a section B-B, in accordance with another embodiment herein;

FIG. 3 depicts a system for assembling a casing, in accordance with an embodiment herein;

FIG. 4 depicts a system for assembling a casing, in accordance with another embodiment herein;

FIG. 5 depicts a method of assembling a casing, in accordance with an embodiment herein;

FIG. 6 depicts a method of assembling a casing, in accordance with another embodiment herein;

FIG. 7 is a schematic optical diagram depicting how light rays emitted from a light source are reflected from a reflecting surface, in accordance with an exemplary embodiment herein;

FIG. 8 is a schematic optical diagram depicting how light rays emitted from a light source are reflected from a reflecting surface, in accordance with another exemplary embodiment herein;

FIG. 9 is a schematic optical diagram depicting how light rays emitted from a light source are reflected from a reflecting surface, in accordance with yet another exemplary embodiment herein;

FIG. 10 is a schematic optical diagram depicting how light rays emitted from a light source are reflected from a reflecting surface, in accordance with still another exemplary embodiment herein;

FIGS. 11A and 11B depict top and front views of a section of a covering component, in accordance with an exemplary embodiment herein; and

FIGS. 12A and 12B depict top and front views of a section of a covering component, in accordance with another exemplary embodiment herein.

### DESCRIPTION OF THE PREFERRED EMBODIMENT

As used in the specification and claims, the singular forms “a”, “an” and “the” include plural references unless the context clearly dictates otherwise. For example, the term “a light source” may include a plurality of light sources unless the context clearly dictates otherwise.

Embodiments herein provide a casing for enclosing an electronic device. In the description of the embodiments herein, numerous specific details are provided, such as examples of components and/or mechanisms, to provide a thorough understanding of embodiments herein. One skilled in the relevant art will recognize, however, that an embodiment herein can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments herein.

### Glossary

Casing: A casing encloses an electronic device, and protects the electronic device from external factors, such as heat, moisture and scratches.

First and second covering components: Covering components are capable of being engaged together mechanically to enclose at least one section of the electronic device in between.

Periphery: A periphery of a region includes a boundary of that region. In certain embodiments herein, the periphery may also include a narrow area in proximity to the boundary of the region.

Reflecting surfaces: A reflecting surface is adapted to reflect light emitted from a light source towards a pre-defined view zone. The reflecting surfaces may, for example, be inclined at a pre-defined angle with respect to a longitudinal axis of the electronic device.

Reflection efficiency: The reflection efficiency of a reflecting surface is defined as the percentage of the amount of light reflected from the reflecting surface with respect to the amount of light falling on the reflecting surface.

View zone: A view zone is a zone through which light reflected from a reflecting surface is visible to a viewer. The view zone may, for example, include at least one of a hole, a transparent portion, or a translucent portion.

Hole: A hole is a three-dimensional empty region formed on a covering component through which light reflected from a reflecting surface is visible to a viewer.

Transparent portion: A transparent portion is a portion on a covering component through which light reflected from a reflecting surface is visible to a viewer. The transparent portion may, for example, be made of a transparent material, such as glass or plastic.

Translucent portion: A translucent portion is a semi-transparent portion on a covering component through which light reflected from a reflecting surface is visible to a viewer. The translucent portion may, for example, allow light to pass through diffusely.

Electronic substrate: An electronic substrate is a substrate that provides mechanical support and electrical connectivity. Examples of the electronic substrate include, but are not limited to, Printed Circuit Boards (PCBs), hybrid microcircuits, and extended PCBs. An extended PCB is a PCB including one or more conductive strips capable of facilitating a Universal Serial Bus (USB) connection.

Electrical component: An electrical component is a component of an electronic device, and is placed on appropriate slots on an electronic substrate to achieve the objective of the electronic device.

Light Source: A light source is a source of light. An example of the light source is a Light-Emitting Diode (LED). A light source may, for example, be used to indicate a current state of an electronic device, in accordance with an embodiment herein.

Molding material: A molding material is a material that may be molded in any desired form. The molding material may, for example, include epoxy resin.

Flash drive: A flash drive is a storage device. At least one electrical component of the flash drive is capable of storing data.

Chip-On-Board (COB) type device: A COB type device is an electronic device manufactured by a COB process. A COB process includes directly placing a bare semiconductor die on an electronic substrate, and electrically connecting the bare semiconductor die to appropriate bond pads on the electronic substrate.

Surface Mount Technology (SMT) type device: An SMT type device is an electronic device manufactured by an SMT process. An SMT process includes mounting an Integrated Circuit (IC) on an electronic substrate.

In accordance with an embodiment herein, a casing for enclosing an electronic device is provided. The electronic device includes one or more electrical components and a light source placed on an electronic substrate. The light source is located at a periphery associated with the electronic device, such that light emitted from the light source travels in a direction parallel to a longitudinal axis of the electronic device. The casing includes a first covering component and a second covering component. The first covering component includes one or more first portions at a first periphery associated with the first covering component. The second covering component includes one or more second portions at a second periphery associated with the second covering component. The first portions and the second portions substantially complement each other. The first portions and the second portions are capable of being engaged together mechanically to enclose at least one section of the electronic device in between the first covering component and the second covering component. The at least one section of the electronic device includes the light source. The second covering component also includes one or more reflecting surfaces adapted to reflect light emitted from the light source towards a pre-defined view zone. In accordance with an embodiment herein, the pre-defined view zone is a zone through which light reflected from the reflecting surfaces is visible to a viewer.

In accordance with an embodiment herein, the reflecting surfaces are inclined at one or more pre-defined angles with respect to the longitudinal axis of the electronic device. The pre-defined angles may, for example, range from 15 degrees to 50 degrees.

In accordance with an additional embodiment herein, the reflecting surfaces are coated with a reflective material.

In accordance with an embodiment herein, at least one of the first covering component or the second covering component includes the pre-defined view zone. The pre-defined view zone may, for example, include at least one of a hole, a transparent portion, or a translucent portion.

In accordance with an additional embodiment herein, the electronic device includes one or more recessed portions at the periphery associated with the electronic device, and at least one of the first covering component or the second covering component includes one or more protruding portions at an inner periphery, such that the recessed portions and the protruding portions engage together mechanically. The shape of the recessed portions may, for example, be substantially complementary to the shape of the protruding portions.

In accordance with an embodiment herein, the casing is molded in any desired shape and/or size from, for example, at least one of acrylic, polyurethane, thermoplastic rubber, or plastic.

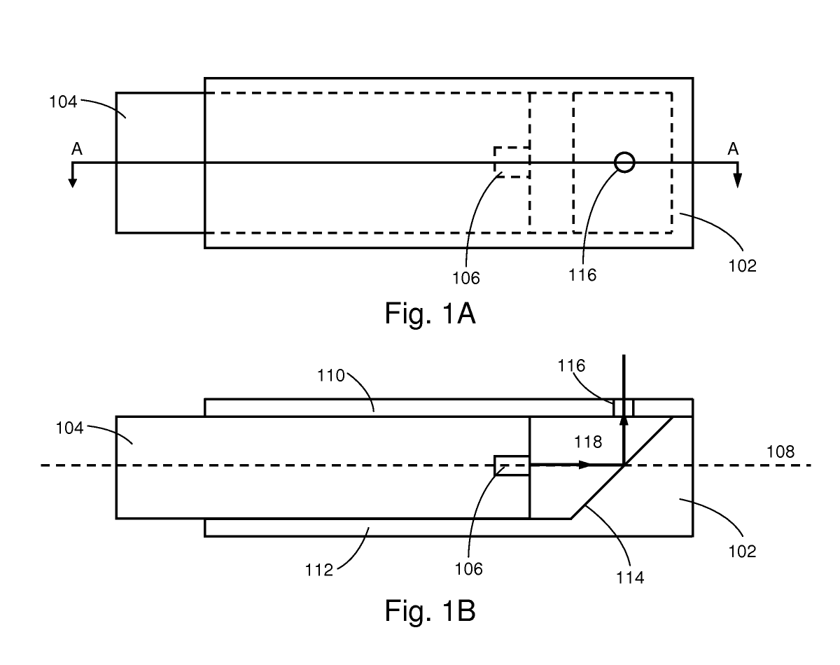

FIG. 1A depicts a top view of a casing 102 enclosing an electronic device 104; FIG. 1B depicts a sectional view of a section A-A cut through casing 102 and electronic device 104, in accordance with an embodiment herein. Electronic device 104 includes one or more electrical components (not shown) and a light source 106 placed on an electronic substrate (not shown). Light source 106 is located at a periphery associated with electronic device 104, such that light emitted from light source 106 travels in a direction parallel to a longitudinal axis 108 of electronic device 104, as shown in FIG. 1B. Casing 102 includes a first covering component 110 and a second covering component 112. First covering component 110 includes one or more first portions (not shown) at a first periphery associated with first covering component 110, while second covering component 112 includes one or more second portions (not shown) at a second periphery associated with second covering component 112. The first portions and the second portions substantially complement each other, and are engaged together mechanically to enclose at least one section of electronic device 104 in between first covering component 110 and second covering component 112. The at least one section of electronic device 104 includes light source 106, as shown in FIG. 1B.

Second covering component 112 also includes one or more reflecting surfaces, shown as a reflecting surface 114. Reflecting surface 114 is adapted to reflect light emitted from light source 106 towards a pre-defined view zone 116 through which light reflected from reflecting surface 114 is visible to a viewer, as shown in FIG. 1B. In accordance with an embodiment herein, reflecting surface 114 is inclined at a pre-defined angle with respect to longitudinal axis 108 of electronic device 104. The pre-defined angle may, for example, range from 15 degrees to 50 degrees.

Reflecting surface 114 may, for example, be a smooth, polished surface. In addition, reflecting surface 114 may be coated with a reflective material to enhance the reflectivity of reflecting surface 114, in accordance with an additional embodiment herein.

In a specific embodiment herein, casing 102 is made of an opaque material. In such a case, reflecting surface 114 may, for example, be a smooth, polished surface of the opaque material. In such a case, the reflection efficiency of reflecting surface 114 may be approximately equal to 90 percent.

In another specific embodiment herein, casing 102 is made of a translucent material. In such a case, reflecting surface 114 may, for example, be a smooth, polished surface of the translucent material. In such a case, the reflection efficiency of reflecting surface 114 may be approximately equal to 50 percent.

In accordance with an embodiment herein, at least one of first covering component 110 or second covering component 112 includes pre-defined view zone 116. With reference to FIG. 1B, first covering component 110 includes pre-defined view zone 116. Pre-defined view zone 116 may, for example, include at least one of a hole, a transparent portion, or a translucent portion. A light ray 118 is reflected from reflecting surface 114 and is transmitted through pre-defined view zone 116, as shown in FIG. 1B.

In accordance with an embodiment herein, pre-defined view zone 116 is a hole covered with a transparent material, such as glass or plastic. For example, the hole may be covered with a transparent lens. The transparent lens may be coated with an anti-reflective coating, so as to avoid transmission losses due to reflection and/or total internal reflection.

In accordance with another embodiment herein, first covering component 110 is made of a translucent material. In such a case, light reflected from reflecting surface 114 is visible to a viewer through a portion of first covering component 110 that acts as pre-defined view zone 116.

In accordance with an embodiment herein, pre-defined view zone 116 may have a shape that is curved, polygonal, or a combination thereof. The size, the shape and/or the location of pre-defined view zone 116 may be chosen, so as to maximize the ratio of the amount of light viewed at pre-defined view zone 116 and the amount of light emitted from light source 106. Accordingly, the size and/or the shape of pre-defined view zone 116 may depend on at least one of: the size and/or shape of first covering component 110, the location of pre-defined view zone 116 on first covering component 110, or the pre-defined angle at which reflecting surface 114 is inclined, in accordance with an embodiment herein.

In accordance with an embodiment herein, electronic device 104 includes one or more recessed portions (not shown) at the periphery associated with electronic device 104, and at least one of first covering component 110 or second covering component 112 includes one or more protruding portions (not shown) at an inner periphery, such that the recessed portions and the protruding portions engage together mechanically. Accordingly, the shape of the recessed portions and the protruding portions may be chosen in a manner that they substantially complement each other.

Consider, for example, that a semicircular recessed portion is cut from electronic device 104. Accordingly, at least one of first covering component 110 or second covering component 112 may be molded with a semicircular protruding portion that substantially complements the semicircular recessed portion. First covering component 110 and second covering component 112 may be molded from, for example, at least one of acrylic, polyurethane, thermoplastic rubber, or plastic in any desired shape and/or size.

In accordance with an additional embodiment herein, first covering component 110 and second covering component 112 are attached to electronic device 104 through a gluing process or an ultrasonic welding process.

It should be noted here that casing 102 is not limited to a specific shape or size of first covering component 110 and second covering component 112. FIGS. 1A-1B are merely an example, which should not unduly limit the scope of the claims herein. One of ordinary skill in the art would recognize many variations, alternatives, and modifications of embodiments herein.

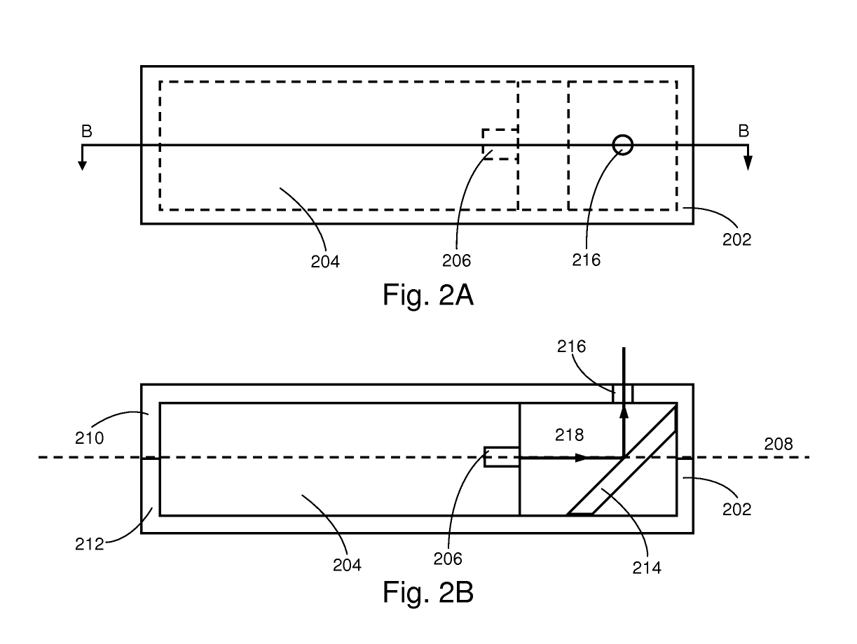

FIG. 2A depicts a top view of a casing 202 enclosing an electronic device 204; FIG. 2B depicts a sectional view of a section B-B cut through casing 202 and electronic device 204, in accordance with another embodiment herein. Electronic device 204 includes one or more electrical components (not shown) and a light source 206 placed on an electronic substrate (not shown). Light source 206 is located at a periphery associated with electronic device 204, such that light emitted from light source 206 travels in a direction parallel to a longitudinal axis 208 of electronic device 204, as shown in FIG. 2B. Casing 202 includes a first covering component 210 and a second covering component 212. First covering component 210 includes one or more first portions (not shown) at a first periphery associated with first covering component 210, while second covering component 212 includes one or more second portions (not shown) at a second periphery associated with second covering component 212. The first portions and the second portions substantially complement each other, and are engaged together mechanically to enclose at least one section of electronic device 204 in between first covering component 210 and second covering component 212. The at least one section of electronic device 204 includes light source 206, as shown in FIG. 2B.

Second covering component 212 also includes one or more reflecting surfaces, shown as a reflecting surface 214. Reflecting surface 214 is adapted to reflect light emitted from light source 206 towards a pre-defined view zone 216 through which light reflected from reflecting surface 214 is visible to a viewer, as shown in FIG. 2B. In accordance with an embodiment herein, reflecting surface 214 is inclined at a pre-defined angle with respect to longitudinal axis 208 of electronic device 204. The pre-defined angle may, for example, range from 15 degrees to 50 degrees.

Reflecting surface 214 may, for example, be a smooth, polished surface. In addition, reflecting surface 214 may be coated with a reflective material to enhance the reflectivity of reflecting surface 214, in accordance with an additional embodiment herein.

In a specific embodiment herein, casing 202 is made of an opaque material. In such a case, reflecting surface 214 may, for example, be a smooth, polished surface of the opaque material. In such a case, the reflection efficiency of reflecting surface 214 may be approximately equal to 90 percent.

In another specific embodiment herein, casing 202 is made of a translucent material. In such a case, reflecting surface 214 may, for example, be a smooth, polished surface of the translucent material. In such a case, the reflection efficiency of reflecting surface 214 may be approximately equal to 50 percent.

In accordance with an embodiment herein, at least one of first covering component 210 or second covering component 212 includes pre-defined view zone 216.

With reference to FIG. 2B, first covering component 210 includes pre-defined view zone 216. Pre-defined view zone 216 may, for example, include at least one of a hole, a transparent portion, or a translucent portion. A light ray 218 is reflected from reflecting surface 214 and is transmitted through pre-defined view zone 216, as shown in FIG. 2B.

In accordance with an embodiment herein, pre-defined view zone 216 is a hole covered with a transparent material, such as glass or plastic. For example, pre-defined view zone 216 may be covered with a transparent lens. The transparent lens may be coated with an anti-reflective coating, so as to avoid transmission losses due to reflection and/or total internal reflection.

In accordance with another embodiment herein, first covering component 210 is made of a translucent material. In such a case, light reflected from reflecting surface 214 is visible to a viewer through a portion of first covering component 210 that acts as pre-defined view zone 216.

In accordance with an embodiment herein, pre-defined view zone 216 may have a shape that is curved, polygonal, or a combination thereof. The size, the shape and/or the location of pre-defined view zone 216 may be chosen, so as to maximize the ratio of the amount of light viewed at pre-defined view zone 216 and the amount of light emitted from light source 206. Accordingly, the size and/or the shape of pre-defined view zone 216 may depend on at least one of: the size and/or shape of first covering component 210, the location of pre-defined view zone 216 on first covering component 210, or the pre-defined angle at which reflecting surface 214 is inclined, in accordance with an embodiment herein.

In accordance with an embodiment herein, electronic device 204 includes one or more recessed portions (not shown) at the periphery associated with electronic device 204, and at least one of first covering component 210 or second covering component 212 includes one or more protruding portions (not shown) at an inner periphery, such that the recessed portions and the protruding portions engage together mechanically. Accordingly, the shape of the recessed portions and the protruding portions may be chosen in a manner that they substantially complement each other.

Consider, for example, that a semicircular recessed portion is cut from electronic device 204. Accordingly, at least one of first covering component 210 or second covering component 212 may be molded with a semicircular protruding portion that substantially complements the semicircular recessed portion. First covering component 210 and second covering component 212 may be molded from, for example, at least one of acrylic, polyurethane, thermoplastic rubber, or plastic in any desired shape and/or size.

In accordance with an additional embodiment herein, first covering component 210 and second covering component 212 are attached to electronic device 204 through a gluing process or an ultrasonic welding process.

It should be noted here that casing 202 is not limited to a specific shape or size of its first covering component 210 and second covering component 212. FIGS. 2A-2B are merely an example, which should not unduly limit the scope of the claims herein. One of ordinary skill in the art would recognize many variations, alternatives, and modifications of embodiments herein.

An embodiment herein provides a flash drive. The flash drive includes an electronic device and a casing enclosing at least one section of the electronic device. The electronic device includes an electronic substrate, one or more electrical components placed on the electronic substrate, and a light source placed on the electronic substrate. At least one of the electrical components is capable of storing data.

The light source is located at a periphery associated with the electronic device. The electrical components and the light source are electrically connected in a pre-defined manner through one or more connectors. In accordance with an embodiment herein, a molding material is molded over a surface of the electronic substrate on which the electrical components and the light source are placed. The molding material covers the light source partially, such that light emitted from the light source travels in a direction parallel to a longitudinal axis of the electronic device.

The casing includes a first covering component and a second covering component. The first covering component includes one or more first portions at a first periphery associated with the first covering component, while the second covering component includes one or more second portions at a second periphery associated with the second covering component. The first portions and the second portions substantially complement each other, and are engaged together mechanically to enclose the at least one section of the electronic device in between the first covering component and the second covering component. The at least one section of the electronic device includes the light source.

The second covering component also includes one or more reflecting surfaces adapted to reflect light emitted from the light source towards a pre-defined view zone through which light reflected from the reflecting surfaces is visible to a viewer. The reflecting surfaces are inclined at one or more pre-defined angles with respect to the longitudinal axis of the electronic device. The pre-defined angles may, for example, range from 15 degrees to 50 degrees.

As mentioned above, the reflecting surfaces may, for example, be smooth, polished surfaces. In addition, the reflecting surfaces may be coated with a reflective material to enhance the reflectivity of the reflecting surfaces, in accordance with an additional embodiment herein.

In accordance with an embodiment herein, at least one of the first covering component and the second covering component includes the pre-defined view zone. The pre-defined view zone may, for example, include at least one of: a hole, a transparent portion, and a translucent portion.

In accordance with an embodiment herein, the electronic device further includes one or more recessed portions at the periphery associated with the electronic device, and at least one of the first covering component or the second covering component includes one or more protruding portions at an inner periphery, such that the recessed portions and the protruding portions engage together mechanically. The shape of the recessed portions may, for example, be substantially complementary to the shape of the protruding portions.

The casing is made from, for example, at least one of acrylic, polyurethane, thermoplastic rubber, or plastic.

In accordance with an embodiment herein, the flash drive is a COB type device. In accordance with another embodiment herein, the flash drive is a SMT type device.

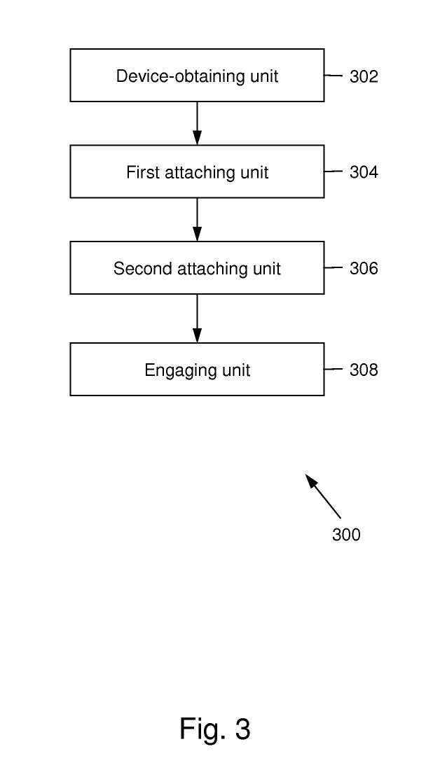

FIG. 3 depicts a system 300 for assembling a casing, in accordance with an embodiment herein. System 300 includes a device-obtaining unit 302, a first attaching unit 304, a second attaching unit 306 and an engaging unit 308.

Device-obtaining unit 302 is adapted to obtain an electronic device. The electronic device includes one or more electrical components and a light source placed on an electronic substrate. The light source is located at a periphery associated with the electronic device, such that light emitted from the light source travels in a direction parallel to a longitudinal axis of the electronic device.

First attaching unit 304 is adapted to attach a first covering component to the electronic device. The first covering component includes one or more first portions at a first periphery associated with the first covering component.

Second attaching unit 306 is adapted to attach a second covering component to the electronic device. The second covering component includes one or more second portions at a second periphery associated with the second covering component. In accordance with an embodiment herein, the first portions and the second portions substantially complement each other.

Engaging unit 308 is adapted to engage the first portions and the second portions together mechanically to enclose at least one section of the electronic device in between the first covering component and the second covering component. The at least one section of the electronic device includes the light source.

In accordance with an embodiment herein, the second covering component includes one or more reflecting surfaces adapted to reflect light emitted from the light source towards a pre-defined view zone through which light reflected from the reflecting surfaces is visible to a viewer. In accordance with an embodiment herein, the reflecting surfaces are inclined at one or more pre-defined angles with respect to the longitudinal axis of the electronic device. The pre-defined angles may, for example, range from 15 degrees to 50 degrees.

FIG. 3 is merely an example, which should not unduly limit the scope of the claims herein. One of ordinary skill in the art would recognize many variations, alternatives, and modifications of embodiments herein.

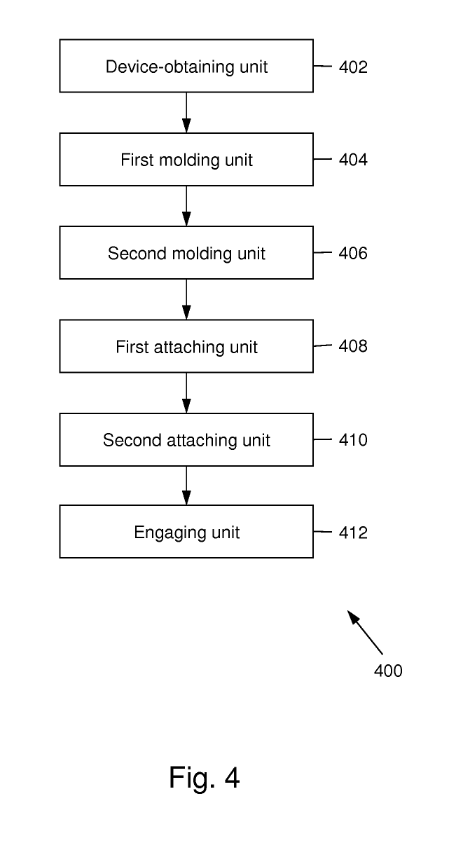

FIG. 4 depicts a system 400 for assembling a casing, in accordance with another embodiment herein. System 400 includes a device-obtaining unit 402, a first molding unit 404, a second molding unit 406, a first attaching unit 408, a second attaching unit 410 and an engaging unit 412.

Device-obtaining unit 402 is adapted to obtain an electronic device. The electronic device includes one or more electrical components and a light source placed on an electronic substrate. The light source is located at a periphery associated with the electronic device, such that light emitted from the light source travels in a direction parallel to a longitudinal axis of the electronic device.

First molding unit 404 is adapted to mold a first covering component. First molding unit 404 is adapted to mold the first covering component with one or more first portions formed at a first periphery associated with the first covering component.

In addition, first molding unit 404 may be adapted to form a pre-defined view zone on the first covering component as desired, in accordance with an embodiment herein. The pre-defined view zone may, for example, include at least one of a hole, a transparent portion, or a translucent portion.

Second molding unit 406 is adapted to mold a second covering component. Second molding unit 406 is adapted to mold the second covering component with one or more second portions formed at a second periphery associated with the second covering component.

In accordance with an embodiment herein, the first portions and the second portions substantially complement each other. Accordingly, first molding unit 404 and second molding unit 406 are adapted to form the first portions and the second portions, such that the shape of the first portions substantially complements the shape of the second portions.

In accordance with an embodiment herein, the second covering component includes one or more reflecting surfaces adapted to reflect light emitted from the light source towards the pre-defined view zone. The reflecting surfaces are inclined at one or more pre-defined angles with respect to the longitudinal axis of the electronic device, in accordance with an embodiment herein. Accordingly, second molding unit 406 may be adapted to form the reflecting surfaces as desired.

In addition, system 400 may include a polishing unit adapted to polish the reflecting surface, in accordance with an embodiment herein. System 400 may also include a coating unit adapted to coat the reflective surfaces with a reflective material, in accordance with an additional embodiment herein.

In accordance with an embodiment herein, the electronic device includes one or more recessed portions on the periphery associated with the electronic device, while the first covering component and the second covering component includes one or more protruding portions on inner peripheries associated with the first covering component and the second covering component. The recessed portions and the protruding portions substantially complement each other. First molding unit 404 and second molding unit 406 may, for example, be adapted to form the protruding portions on the first covering component and the second covering component, respectively. In addition, system 400 may include a cutting unit adapted to cut the recessed portions from the electronic device as desired.

First attaching unit 408 is adapted to attach the first covering component to the electronic device, while second attaching unit 410 is adapted to attach the second covering component to the electronic device. First attaching unit 408 and second attaching unit 410 may be adapted to engage the protruding portions and the recessed portions together mechanically.

Engaging unit 412 is adapted to engage the first portions and the second portions together mechanically to enclose at least one section of the electronic device in between the first covering component and the second covering component. The at least one section of the electronic device includes the light source.

FIG. 4 is merely an example, which should not unduly limit the scope of the claims herein. One of ordinary skill in the art would recognize many variations, alternatives, and modifications of embodiments herein.

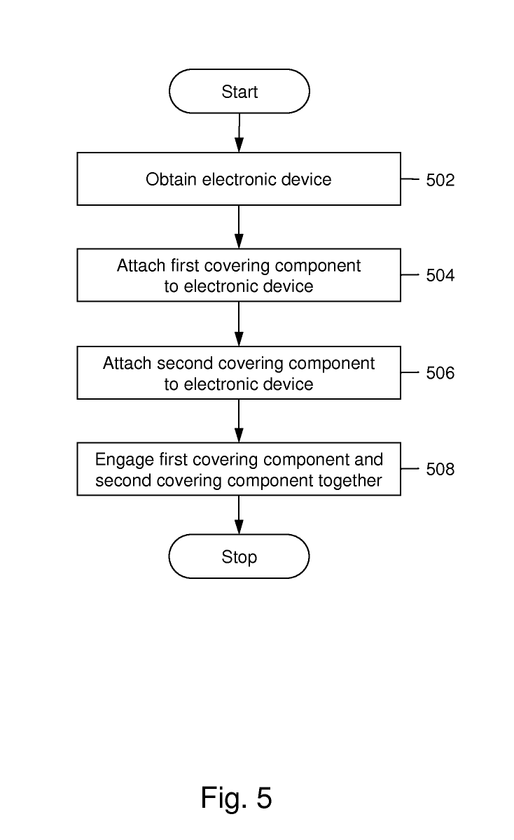

FIG. 5 depicts a method of assembling a casing, in accordance with an embodiment herein. The method is illustrated as a collection of steps in a logical flow diagram, which represents a sequence of steps that can be implemented in hardware, software, or a combination thereof.

At step 502, an electronic device is obtained. The electronic device includes one or more electrical components and a light source placed on an electronic substrate. The light source is located at a periphery associated with the electronic device, such that light emitted from the light source travels in a direction parallel to a longitudinal axis of the electronic device.

At step 504, a first covering component is attached to the electronic device. The first covering component includes one or more first portions at a first periphery associated with the first covering component.

At step 506, a second covering component is attached to the electronic device. The second covering component includes one or more second portions at a second periphery associated with the second covering component. In accordance with an embodiment herein, the first portions and the second portions substantially complement each other.

At step 508, the first portions and the second portions are engaged together mechanically to enclose at least one section of the electronic device in between the first covering component and the second covering component. The at least one section of the electronic device includes the light source.

In accordance with an embodiment herein, the second covering component includes one or more reflecting surfaces adapted to reflect light emitted from the light source towards a pre-defined view zone through which light reflected from the reflecting surfaces is visible to a viewer. In accordance with an embodiment herein, the reflecting surfaces are inclined at one or more pre-defined angles with respect to the longitudinal axis of the electronic device. The pre-defined angles may, for example, range from 15 degrees to 50 degrees.

It should be noted here that steps 502-508 are only illustrative and other alternatives can also be provided where steps are added, one or more steps are removed, or one or more steps are provided in a different sequence without departing from the scope of the claims herein.

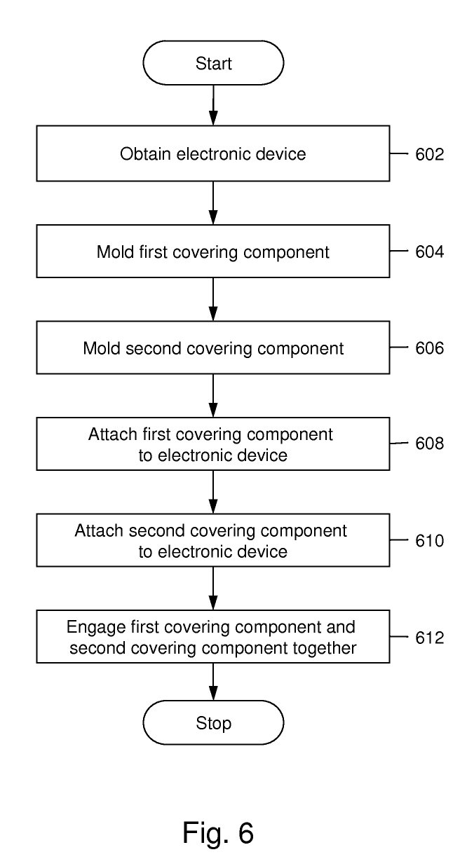

FIG. 6 depicts a method of assembling a casing, in accordance with another embodiment herein. The method is illustrated as a collection of steps in a logical flow diagram, which represents a sequence of steps that can be implemented in hardware, software, or a combination thereof.

At step 602, an electronic device is obtained. The electronic device includes one or more electrical components and a light source placed on an electronic substrate. The light source is located at a periphery associated with the electronic device, such that light emitted from the light source travels in a direction parallel to a longitudinal axis of the electronic device.

At step 604, a first covering component is molded. The first covering component so molded includes one or more first portions formed at a first periphery associated with the first covering component. In addition, a pre-defined view zone may be formed on the first covering component at step 604. The pre-defined view zone may, for example, include at least one of a hole, a transparent portion, or a translucent portion.

At step 606, a second covering component is molded. The second covering component so molded includes one or more second portions formed at a second periphery associated with the second covering component.

In accordance with an embodiment herein, the first portions and the second portions substantially complement each other. Accordingly, the shape of the first portions formed at step 604 substantially complements the shape of the second portions formed at step 606.

In accordance with an embodiment herein, the second covering component includes one or more reflecting surfaces adapted to reflect light emitted from the light source towards the pre-defined view zone. Accordingly, the reflecting surfaces may be formed as desired at step 606.

Additionally, a step of inclining the reflecting surfaces at one or more pre-defined angles with respect to the longitudinal axis of the electronic device may be performed. The pre-defined angles range from 15 degrees to 50 degrees.

In accordance with an embodiment herein, a step of polishing the reflecting surface may be performed. In accordance with an additional embodiment herein, a step of coating the reflective surfaces with a reflective material may be performed.

In accordance with an embodiment herein, the electronic device includes one or more recessed portions on the periphery associated with the electronic device, while the first covering component and the second covering component includes one or more protruding portions on inner peripheries associated with the first covering component and the second covering component. The recessed portions and the protruding portions substantially complement each other. Accordingly, the protruding portions on the first covering component and the second covering component may be formed at step 604 and step 606, respectively. In addition, a step of cutting the recessed portions from the electronic device may be performed.

At step 608, the first covering component is attached to the electronic device. At step 610, the second covering component is attached to the electronic device. In accordance with step 608 and step 610, the protruding portions and the recessed portions are engaged together mechanically.

At step 612, the first portions and the second portions are engaged together mechanically to enclose at least one section of the electronic device in between the first covering component and the second covering component. The at least one section of the electronic device includes the light source.

It should be noted here that steps 602-612 are only illustrative and other alternatives can also be provided where steps are added, one or more steps are removed, or one or more steps are provided in a different sequence without departing from the scope of the claims herein.

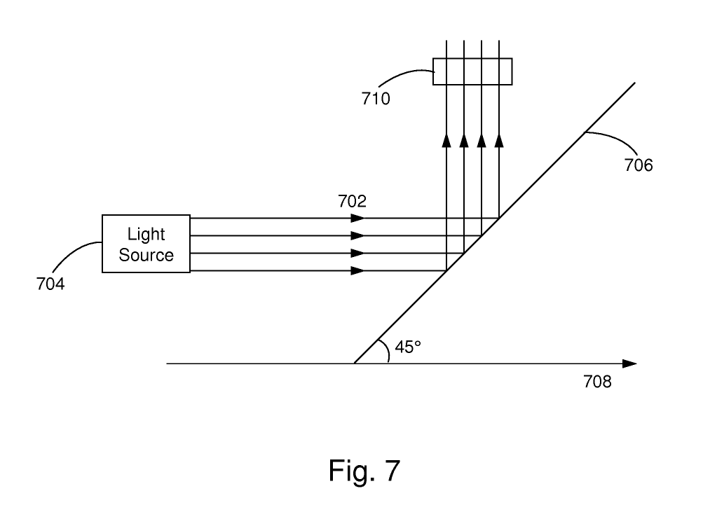

FIG. 7 is a schematic optical diagram depicting how light rays 702 emitted from a light source 704 are reflected from a reflecting surface 706, in accordance with an exemplary embodiment herein. With reference to FIG. 7, reflecting surface 706 is inclined at an angle of 45 degrees with respect to the direction in which light rays 702 travel, depicted by an arrow 708. Light rays 702 are reflected from reflecting surface 706 towards a pre-defined view zone 710, as shown in FIG. 7.

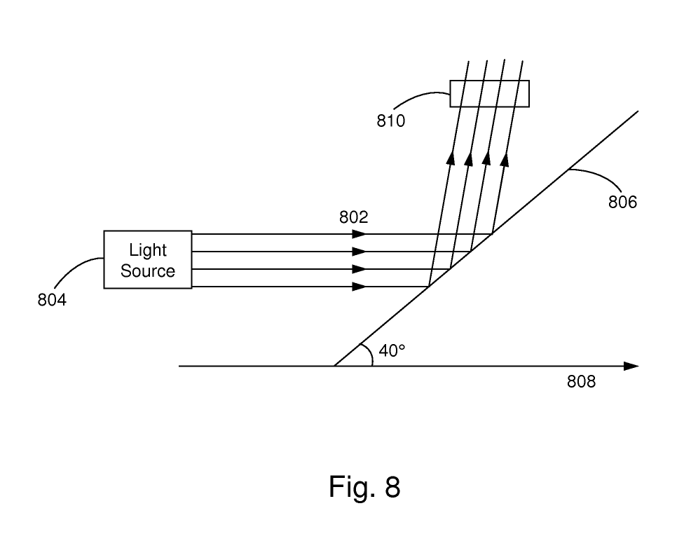

FIG. 8 is a schematic optical diagram depicting how light rays 802 emitted from a light source 804 are reflected from a reflecting surface 806, in accordance with another exemplary embodiment herein. With reference to FIG. 8, reflecting surface 806 is inclined at an angle of 40 degrees with respect to the direction in which light rays 802 travel, depicted by an arrow 808. Light rays 802 are reflected from reflecting surface 806 towards a pre-defined view zone 810, as shown in FIG. 8.

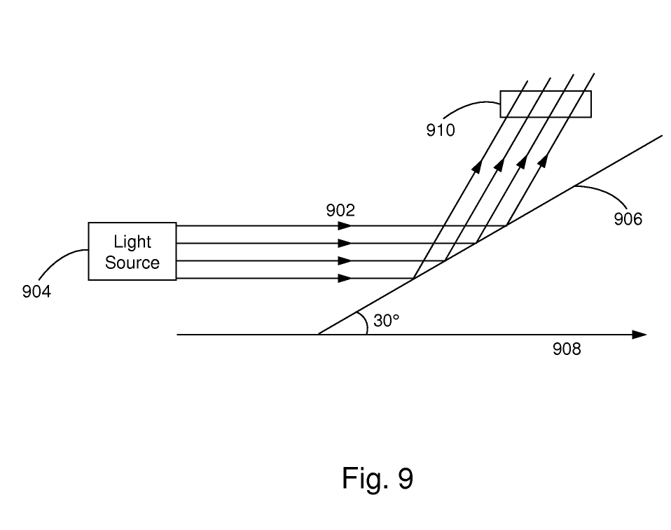

FIG. 9 is a schematic optical diagram depicting how light rays 902 emitted from a light source 904 are reflected from a reflecting surface 906, in accordance with yet another exemplary embodiment herein. With reference to FIG. 9, reflecting surface 906 is inclined at an angle of 30 degrees with respect to the direction in which light rays 902 travel, depicted by an arrow 908. Light rays 902 are reflected from reflecting surface 906 towards a pre-defined view zone 910, as shown in FIG. 9.

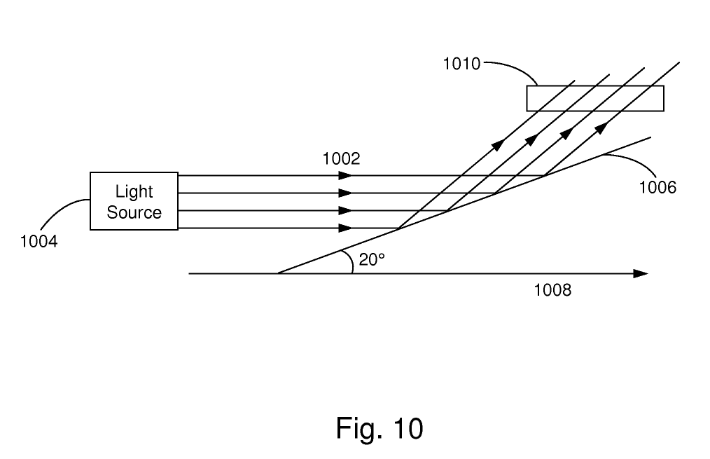

FIG. 10 is a schematic optical diagram depicting how light rays 1002 emitted from a light source 1004 are reflected from a reflecting surface 1006, in accordance with still another exemplary embodiment herein. With reference to FIG. 10, reflecting surface 1006 is inclined at an angle of 20 degrees with respect to the direction in which light rays 1002 travel, depicted by an arrow 1008. Light rays 1002 are reflected from reflecting surface 1006 towards a pre-defined view zone 1010, as shown in FIG. 10.

FIGS. 7, 8, 9 and 10 depict how light rays emitted from a light source are reflected farther away from the light source, as the angle of a reflecting surface with respect to the direction of the light rays is decreased. In addition, reflected light rays tend to spread as the angle decreases. Accordingly, the size, the shape and/or the location of the pre-defined view zone may be chosen suitably, so that maximum amount of the reflected light rays is transmitted towards a pre-defined view zone.

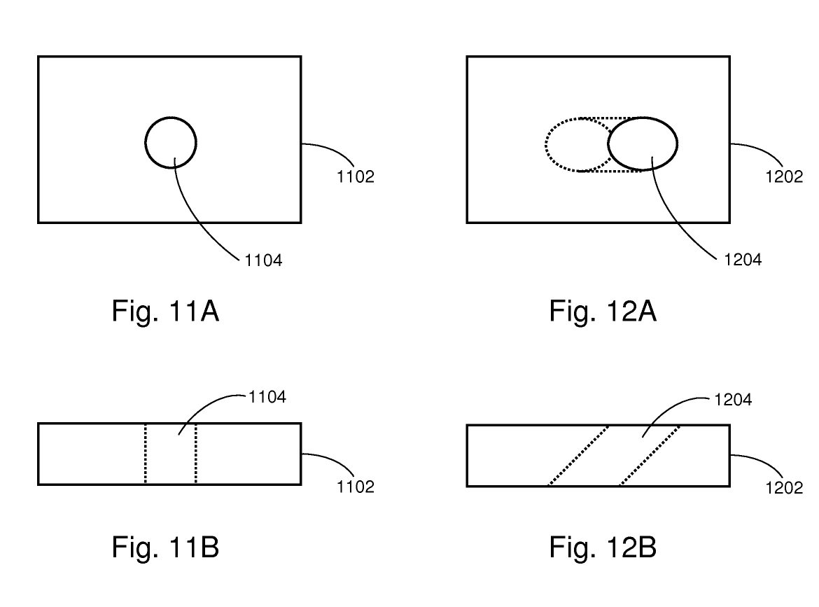

FIGS. 11A and 11B depict top and front views of a section of a covering component 1102 including a pre-defined view zone 1104, in accordance with an exemplary embodiment herein. With reference to FIGS. 11A-11B, pre-defined view zone 1104 is circular in shape and is made vertically across component 1102.

FIGS. 12A and 12B depict top and front views of a section of a covering component 1202 including a pre-defined view zone 1204, in accordance with another exemplary embodiment herein. With reference to FIGS. 12A-12B, pre-defined view zone 1204 is oval in shape and is made obliquely across component 1202.

FIGS. 11A-11B and 12A-12B are merely examples, which should not unduly limit the scope of the claims herein. One of ordinary skill in the art would recognize many variations, alternatives, and modifications of embodiments herein. For example, a hole, a transparent portion or a translucent portion may be formed on a covering component as shown in FIGS. 11A-11B and 12A-12B.

In one embodiment herein, a COB type device is manufactured by a COB process. As the COB process requires less space, an electronic substrate of a small size may be used. Consequently, the overall size of the COB type device may also be reduced. For example, the dimensions of the COB type device may be as follows: length ranging from 20 mm to 30 mm, width ranging from 10 mm to 15 mm, and height ranging from 1 mm to 2 mm. Such a small-sized COB type device is easy to carry and easy to use.

Consequently, the COB type device may be designed in several forms. In one example, the COB type device may be designed in the form of a small-sized chip that may be carried in a wallet. In another example, the COB type device may be designed in the form of a key ring that is easy to carry.

In case when the COB type device is a flash drive, the storage capacity of the COB type device may be increased without changing the overall dimensions of its casing.

Moreover, the cost of manufacture is reduced, as small-sized electronic substrates and bare semiconductor dies are used.

Embodiments herein provide a casing suitable for enclosing an electronic device with a light source. The casing allows transmission of light emitted by the light source through a pre-defined view zone, while protecting the electronic device from external factors, such as heat, moisture and scratches. In this way, the casing allows a viewer to view the light from a comfortable position.

This application may disclose several numerical range limitations that support any range within the disclosed numerical ranges even though a precise range limitation is not stated verbatim in the specification because the embodiments of the invention could be practiced throughout the disclosed numerical ranges. Finally, the entire disclosure of the patents and publications referred in this application, if any, are hereby incorporated herein in entirety by reference.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed as being new and desired to be protected by Letters Patent of the United States is as follows:

1. A casing for enclosing an electronic device, said electronic device comprising one or more electrical components and a light source placed on an electronic substrate, said light source being located at a periphery associated with said electronic device, such that light emitted from said light source travels in a direction parallel to a longitudinal axis of said electronic device, said casing comprising:
a first covering component, said first covering component comprising one or more first portions at a first periphery associated with said first covering component; and
a second covering component, said second covering component comprising:
one or more second portions at a second periphery associated with said second covering component, wherein said first portions and said second portions substantially complement each other, said first portions and said second portions are capable of being engaged together mechanically to enclose at least one section of said electronic device in between said first covering component and said second covering component, said at least one section comprising said light source; and
one or more reflecting surfaces adapted to reflect light emitted from said light source towards a pre-defined view zone, said pre-defined view zone being a zone through which light reflected from said reflecting surfaces is visible to a viewer, said reflecting surfaces being inclined at one or more pre-defined angles with respect to said longitudinal axis of said electronic device.

2. The casing of claim 1, wherein said pre-defined angles range from 15 degrees to 50 degrees.

3. The casing of claim 1, wherein said reflecting surfaces are coated with a reflective material.

4. The casing of claim 1, wherein at least one of said first covering component and said second covering component comprises said pre-defined view zone, said pre-defined view zone comprises at least one of: a hole, a transparent portion, and a translucent portion.

5. The casing of claim 1, wherein said electronic device comprises one or more recessed portions at said periphery associated with said electronic device, and at least one of said first covering component and said second covering component comprises one or more protruding portions at an inner periphery, such that said recessed portions and said protruding portions substantially complement each other and engage together mechanically.

6. The casing of claim 1 is made of at least one material selected from the group consisting of acrylic, polyurethane, thermoplastic rubber, and plastic.

7. A flash drive comprising:
an electronic device comprising:
an electronic substrate;
one or more electrical components placed on said electronic substrate;
a light source placed on said electronic substrate, said light source being located at a periphery associated with said electronic device;
one or more connectors for electrically connecting said electrical components and said light source in a pre-defined manner; and
a molding material molded over a surface of said electronic substrate on which said electrical components and said light source are placed, said molding material covers said light source partially, such that light emitted from said light source travels in a direction parallel to a longitudinal axis of said electronic device; and
a casing for enclosing at least one section of said electronic device, said at least one section comprising said light source, said casing comprising:
a first covering component, said first covering component comprising one or more first portions at a first periphery associated with said first covering component;
a second covering component, said second covering component comprising:
one or more second portions at a second periphery associated with said second covering component, wherein said first portions and said second portions substantially complement each other, said first portions and said second portions are capable of being engaged together mechanically to enclose said at least one section of said electronic device in between said first covering component and said second covering component; and
one or more reflecting surfaces adapted to reflect light emitted from said light source towards a pre-defined view zone, said pre-defined view zone being a zone through which light reflected from said reflecting surfaces is visible to a viewer, said reflecting surfaces being inclined at one or more pre-defined angles with respect to said longitudinal axis of said electronic device.

8. The flash drive of claim 7, wherein said pre-defined angles range from 15 degrees to 50 degrees.

9. The flash drive of claim 7, wherein said reflecting surfaces are coated with a reflective material.

10. The flash drive of claim 7, wherein at least one of said first covering component and said second covering component comprises said pre-defined view zone, said pre-defined view zone comprises at least one of: a hole, a transparent portion, and a translucent portion.

11. The flash drive of claim 7, wherein said electronic device comprises one or more recessed portions at said periphery associated with said electronic device, and at least one of said first covering component and said second covering component comprises one or more protruding portions at an inner periphery, such that said recessed portions and said protruding portions substantially complement each other and engage together mechanically.

12. The flash drive of claim 7, wherein said casing is made of at least one material selected from the group consisting of acrylic, polyurethane, thermoplastic rubber, and plastic.

13. The flash drive of claim 7 is a Chip-On-Board (COB) type device.

14. The flash drive of claim 7 is a Surface Mount Technology (SMT) type device.

15. A method of assembling a casing, said method comprising:
obtaining an electronic device, said electronic device comprising one or more electrical components and a light source placed on an electronic substrate, said light source being located at a periphery associated with said electronic device, such that light emitted from said light source travels in a direction parallel to a longitudinal axis of said electronic device;
attaching a first covering component to said electronic device, said first covering component comprising one or more first portions at a first periphery associated with said first covering component;
attaching a second covering component to said electronic device, said second covering component comprising one or more second portions at a second periphery associated with said second covering component, wherein said first portions and said second portions substantially complement each other; and
engaging said first portions and said second portions together mechanically to enclose at least one section of said electronic device in between said first covering component and said second covering component, said at least one section comprising said light source,
further wherein said second covering component comprises one or more reflecting surfaces adapted to reflect light emitted from said light source towards a pre-defined view zone, said pre-defined view zone being a zone through which light reflected from said reflecting surfaces is visible to a viewer.

16. The method of claim 15 further comprising inclining said reflecting surfaces at one or more pre-defined angles with respect to said longitudinal axis of said electronic device.

17. The method of claim 16, wherein said pre-defined angles range from 15 degrees to 50 degrees.

18. The method of claim 15 further comprising coating said reflecting surfaces with a reflective material.

19. The method of claim 15 further comprising forming said pre-defined view zone on at least one of said first covering component and said second covering component, wherein said pre-defined view zone comprises at least one of: a hole, a transparent portion, and a translucent portion.

20. The method of claim 15 further comprising:
forming one or more recessed portions on said periphery associated with said electronic device;
forming one or more protruding portions on an inner periphery of at least one of said first covering component and said second covering component, such that said protruding portions and said recessed portions substantially complement each other; and
engaging said protruding portions and said recessed portions together mechanically.
